(19) United States
(12) Patent Application Publication
(10) Pub. No.: US 2013/0239534 A1
(43) Pub. Date: Sep. 19, 2013

(54) LINE TRIMMING DEVICE

(71) Applicant: Blaine Branden, Sabin, MN (US)

(72) Inventor: Blaine Branden, Sabin, MN (US)

(21) Appl. No.: 13/612,674

(22) Filed: Sep. 12, 2012

Related U.S. Application Data
(63) Continuation-in-part of application No. 12/877,472, filed on Sep. 8, 2010, now abandoned.

(51) Int. Cl. A01D 34/01

(52) U.S. Cl. CPC A01D 34/015
USPC 56/12.7

(57) ABSTRACT

A device allowing a user to removably attach a weed line trimming device to a lawnmower deck, allowing a user to activate the weed trimming device or automatically engaging during the mowing of a yard to trim areas beside the mower while mowing the yard, eliminating duplicate effort and also to relieve the stress of carrying the weed trimming device.

### CROSS-REFERENCE TO RELATED APPLICATIONS

This application is a continuation in part of U.S. patent application Ser. No. 12/877,472, filed Sep. 8, 2010. U.S. patent application Ser. No. 12/877,472 is incorporated herein by reference in its entirety.

### BACKGROUND

A conventional mower is unable to cut grass and weeds immediately surrounding a fixed object, such as trees and buildings. This is because the mower blades are surrounded by the mower deck. Furthermore, the mower deck itself is encumbered by other parts, usually a cowling and wheels. These other parts of the mower create a gap between the fixed object and the cutting area. In this gap, the grass is not cut. To cut this grass a separate weed or grass line trimming device is usually employed to go back and trim the grass near the fixed objects. This second step of trimming the areas near the fixed objects can be time consuming. Although some devices have been developed to attach line trimming devices to lawnmowers, these devices can be difficult to attach to a mower, and once attached, they are not easily removed. Also, these devices generally require robust mounting hardware. Improvements are desired.

### SUMMARY

A removable trimming device for a lawnmower is disclosed. In one embodiment, the device includes a trimming device head assembly including a line trimming device head rotatably mounted to a flexible bracket. The flexible bracket may have a magnetized face for removably mounting the trimming device head assembly to the lawnmower. In one embodiment, the device also includes a flexible drive shaft having a first end and a second end wherein the first end is connected to the line trimming device head. The device may also include an electrical power source including a mounting magnet and an electric motor connected to the second end of the flexible drive shaft. In one embodiment, the electrical power source is configured to provide rotational energy to the line trimming device head through the flexible drive shaft. In one embodiment, the mounting magnet is configured to removably mount the electrical power source to the lawnmower.

### DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a perspective view of a first embodiment of a trimming device having features that are examples of aspects in accordance with the principles of the present disclosure attached to a riding lawnmower.

FIG. 2 is a perspective view of the trimming device of FIG. 1 attached to a push-type lawnmower.

FIG. 3 is an expanded perspective view of the trimming device and lawnmower of FIG. 2.

FIG. 4 is a top view of the trimming device and lawnmower of FIG. 2.

FIG. 5 is a top view of the trimming device and lawnmower of FIG. 2 in use as it approaches an object.

FIG. 6 is a top view of the trimming device and lawnmower of FIG. 2 in use when in contact with an object.

FIG. 7 is a perspective view of the trimming device of FIG. 1 being attached to a push-type lawnmower using an adhesive insert.

FIG. 8 is an expanded perspective view of the trimming device and lawnmower of FIG. 5.

FIG. 9 is a top view of the trimming device and lawnmower of FIG. 5.

FIG. 10 is a schematic top view of the trimming device shown in FIGS. 2 with an additional trimming head assembly.

FIG. 11 is a schematic side view of a trimming head assembly of the trimming device shown in FIG. 1 with an added guide disk.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The disclosure is related to a removable trimming device attachable to a lawnmower deck. The trimming device can be activated during mowing to trim areas next to the mower. The trimming device can be activated manually or can be configured to automatically activate when contacted by a surface such as a tree or a fence. The trimming device is fastened to the lawn mower by a magnetic contact attachment. As shown, the trimming device allows the individual mowing the lawnmower to trim next to the fixed objects while mowing. This eliminates the second step of backtracking over mowed areas to trim around the fixed objects.

The disclosed trimming device makes the addition of a weed line trimming device to a conventional riding or push mower very convenient. It allows the user to attach the weed line trimming device with the simple use of a magnet. The magnetic bracket holds the weed line trimming device in places on the side of the mower deck. The weed line trimming device is then easily activated either with a manual switch mounted on the lawnmower controls or with a trigger switch when the weed line trimming device approaches and object and the trigger switch touches the object, as discussed in more detail below.

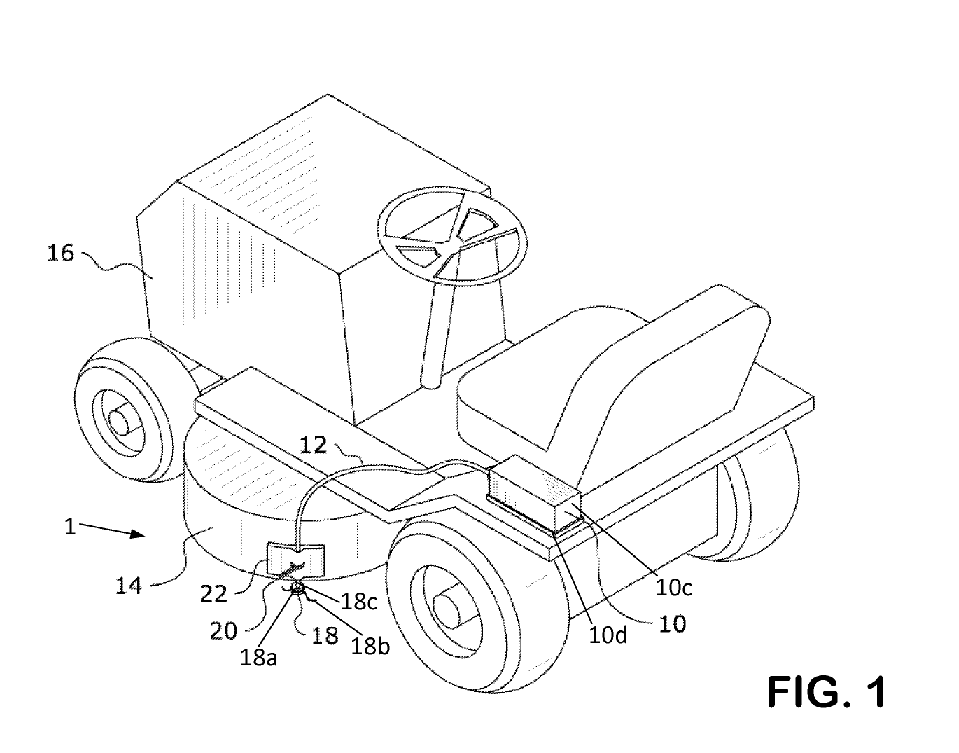

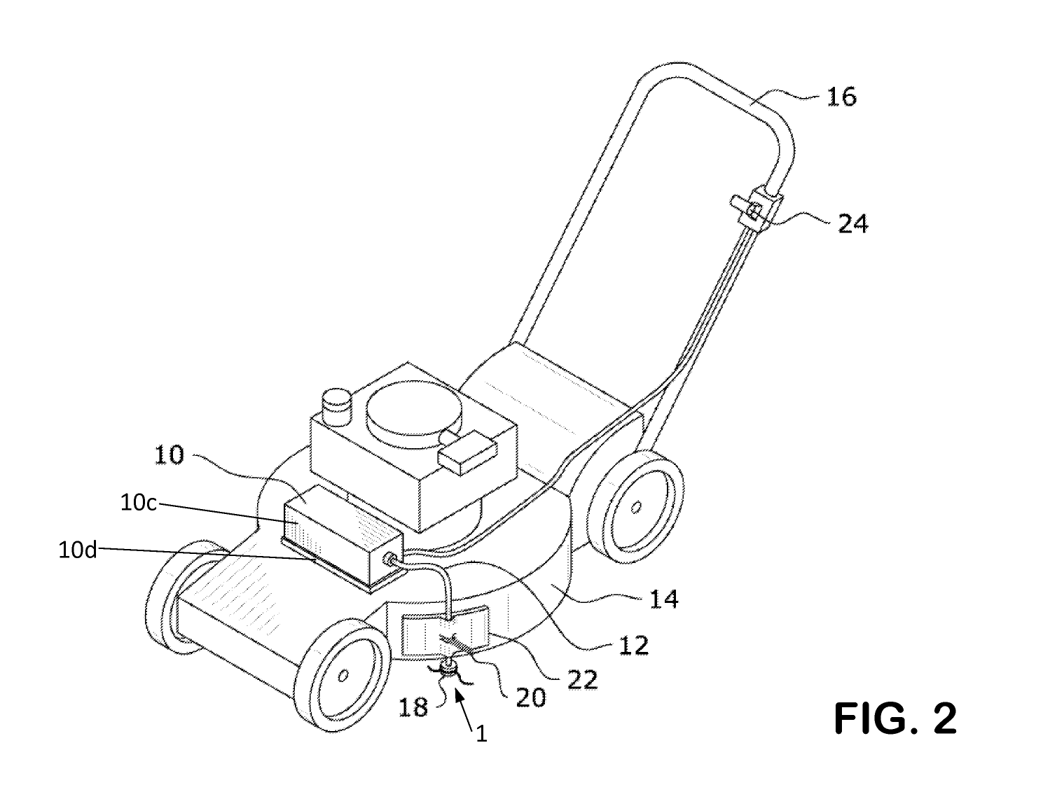

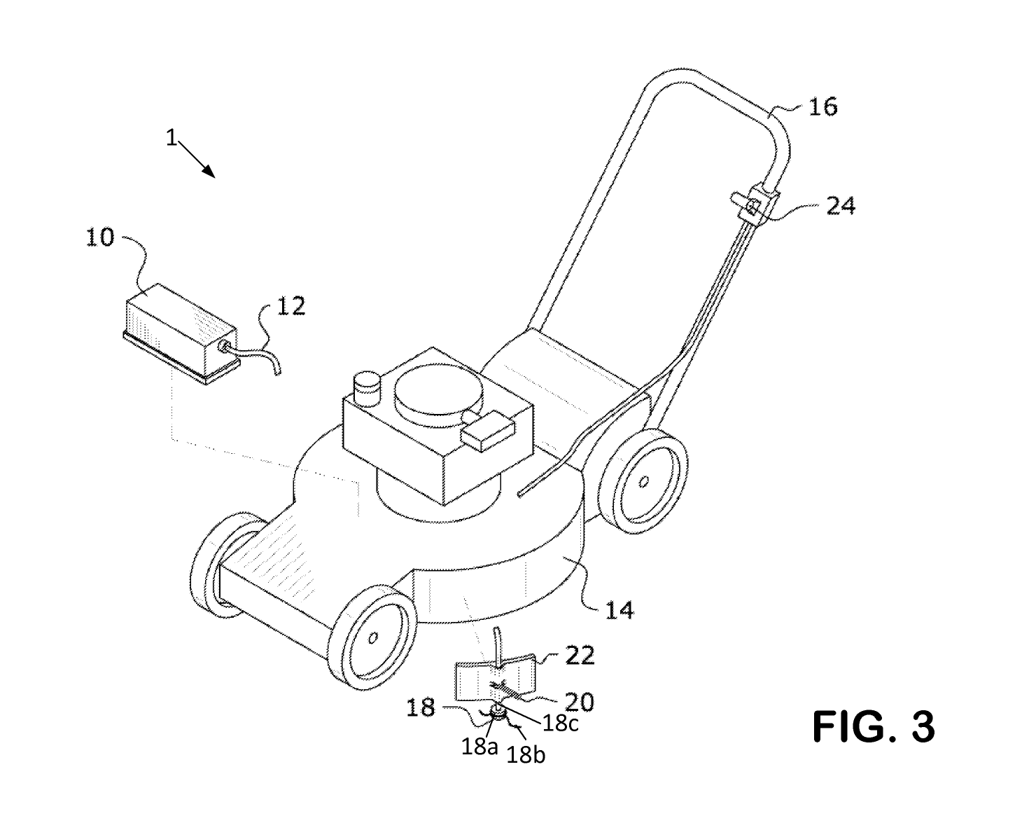

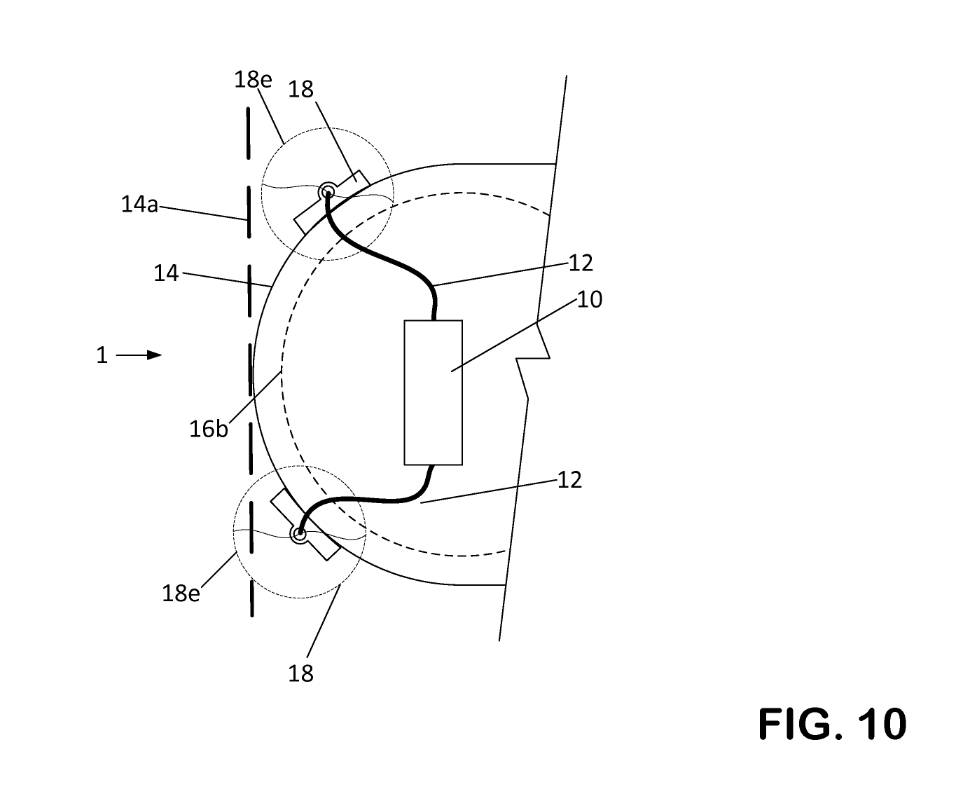

Referring to FIGS. 1-7, a first embodiment of a trimming device 1 is shown attached to a lawnmower 16 having a mowing deck 14. Within the mowing deck 14 is a cutting blade 16a that defines a cutting area 16b. As shown in FIG. 1, the trimming device 1 is attached to a riding lawnmower 16 while in FIGS. 2-7, the trimming device 1 is shown as being attached a push-type mower 16. FIG. 10 shows a trimming device 1 in which multiple trimming heads are provided. As shown, trimming device 1 includes a power source 10, a flexible drive shaft 12, at least one trimming head assembly 18, and a mounting bracket assembly 22. The trimming device 1 may also be provided with a contact trigger 20, as shown in FIGS. 1-7, and/or a manual trigger 24, as shown in FIGS. 2-3.

As shown, the trimming head assembly 18 includes a rotatable trimming head 18a to which a pair of trimming lines 18b spaced 180 degrees apart are attached. The trimming device 1 may have multiple trimming head assemblies 18, as shown in FIG. 10. Although two trimming lines 18b are shown for each assembly 18, more or fewer lines are possible. For example, three trimming lines 18b spaced 120 degrees apart or four trimming lines 18b spaced 90 degrees apart could be used. Trimming lines 18b may be in the form of thin flexible plastic lines or wires. In operation, the trimming head 18a is rapidly rotated in a horizontal plane, adjacent to fixed rod 18c, thereby causing the trimming lines 18b to rotate as well.

In one embodiment, the trimming lines 18b are rotated perpendicular to the blades of grass or the stems of weeds, thereby cutting the weeds or grass. As shown, the lines 18b extend in a generally horizontal plane from the trimming head 18a and define a cutting area 18e. The cutting area 18e may be of any desired diameter, for example from about 3 to about 7 inches, and more preferably from about 5 to about 6 inches.

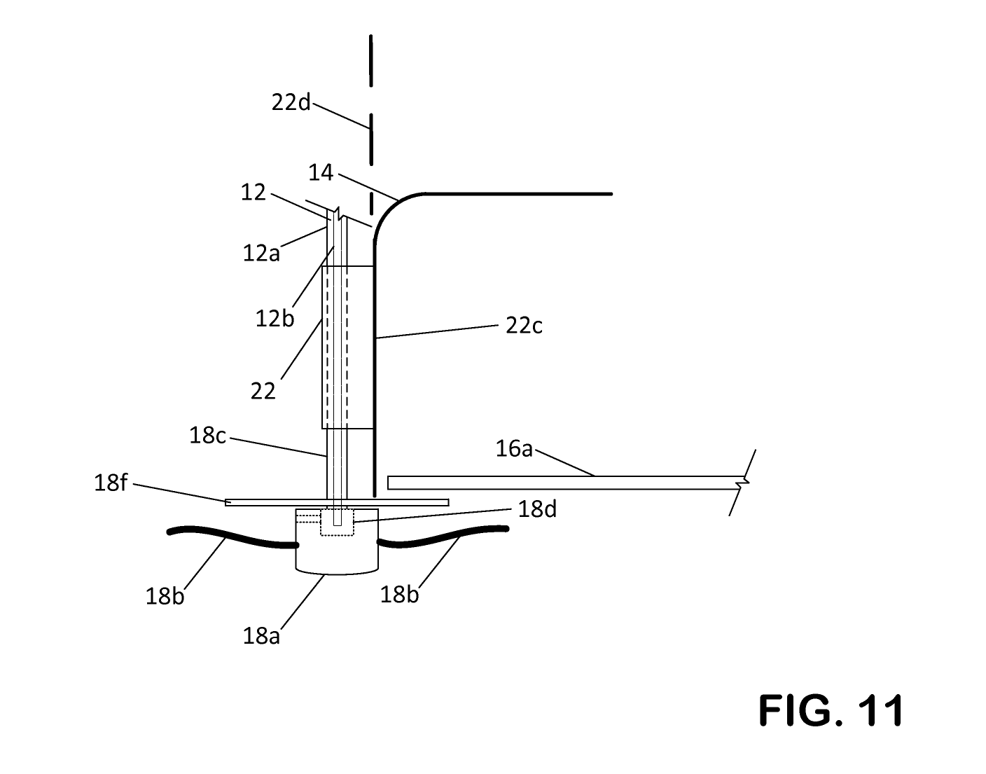

In the embodiment shown, the trimming head assembly 18 has a low profile, meaning the line trimming device is not of the type where the line uncoils from the head, but rather the head or the line its self is manually replaced and provides for a smaller more compact device. As most easily seen at FIG. 11, the trimming head assembly 18 may include an integral chuck 18d for removably connecting to the trimming head 18a to the trimming head assembly 18.

As most easily seen at FIG. 11, the trimming device 18 may also be provided with a guide disk 18f to protect the trimming lines 18b from coming into contact with the bottom edge of the lawnmower deck 14 and/or the rotating cutting blade(s) 16a of the lawnmower 16. In one embodiment, the guide disk 18f is a solid circular or disk shaped body with a central aperture and is disposed about the rod 18c such that it can freely spin when in contact with the trimming head 18a. In one embodiment, the disk is about 1 to about 4 inches in diameter, and more preferably from about 2 inches to about 3 inches. In one embodiment, the guide disk 18f is made from a plastic with high wear potential. It is noted that the guide disk allows the trimming head 18a to be mounted higher with respect to the bottom edge of the deck 14 and the lawnmower blade(s) 16a, as the risk of interference between these components and the trimming lines 18b is reduced by the presence of the disk 18f.

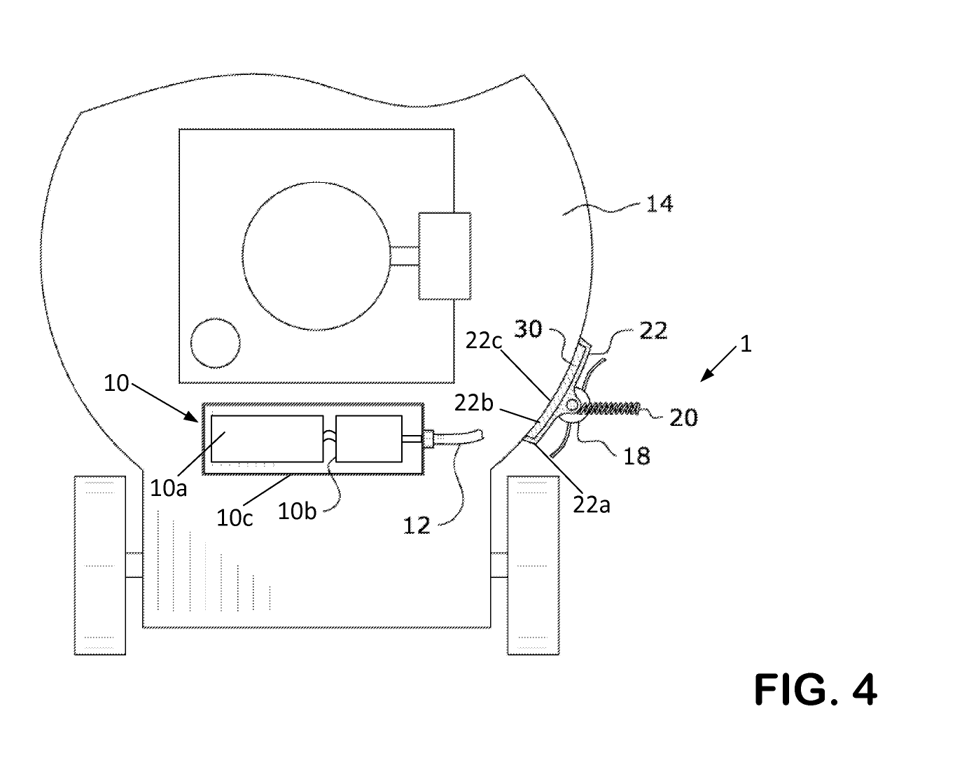

A power source 10, via drive shaft 12 (discussed later), provides rotational energy to the trimming head 18a. In one embodiment, power source 10 includes a rechargeable battery 10a and an electric motor 10b in electrical communication with battery 10a. As can be seen at FIG. 4, battery 10a and electric motor 10b are disposed in a weatherproof housing 10c. However, it is noted that battery 10a and motor 10b could be located separately, for example, motor 10b could be mounted proximate to the trimming head 18a in a direct drive application wherein electrical cabling could take the place of the drive shaft 12. The power source 10 rechargeable battery 10a may be of any type suitable for powering an electric motor, for example a nickel-metal hydride battery or a lithium ion battery. With respect to the embodiment shown in FIG. 19, the power source 10 may be provided with two output sources, for example two electrical motors 10b coupled to two drive shafts 12.

In other embodiments, the power source 10 may be the lawnmower engine 16a itself, a separate internal combustion engine, or a hydraulic system including hydraulic motors powered by the lawnmower 16 or the separate engine. Additionally, the lawnmower 16 can be configured to maintain the charge in the power source 10, where the power source 10 is a battery.

The power source 10 may be configured to be removably attachable to the lawnmower 16. For example, power source 10 may be provided with a magnetic base mounting magnet 10d. As shown, magnetic base 10d allows for the power source to be located on a variety of surfaces of a lawnmower, for example, the fender of a riding lawnmower 16 (see FIG. 1) or the deck 14 of a push-type mower 16 (see FIG. 2). As shown, the magnetic base 10d is connected to and supports the housing 10c. In one embodiment, the magnetic base 10d includes a rare earth magnet formed from rare earth elements. In one embodiment, the magnetic base 10d is made from a flexible material.

The rotatable trimming head 18a of the trimming device 1 may be activated in a number of ways, for example by a manual switch and/or an automatic switch. As most easily seen at FIGS. 2 and 3, trimming device 1 is provided with both a manual switch 24 and an automatic switch 20. The manual switch 24 may be configured to move between an ON position and an OFF position wherein the trimming head is activated in the ON position and prevented from being activated in the OFF position. The manual switch may also have an AUTOMATIC position in which the automatic switch 20 is allowed to activate the rotatable trimming head 18a. Alternatively, the power source can be configured with an ON/OFF switch that allows the automatic switch 20 to control power to the trimming head 18a. Other configurations are possible. In the automatic operating mode, the rotatable trimming head 18a is activated when the automatic switch 20 comes into contact with an object 28, for example a tree or building.

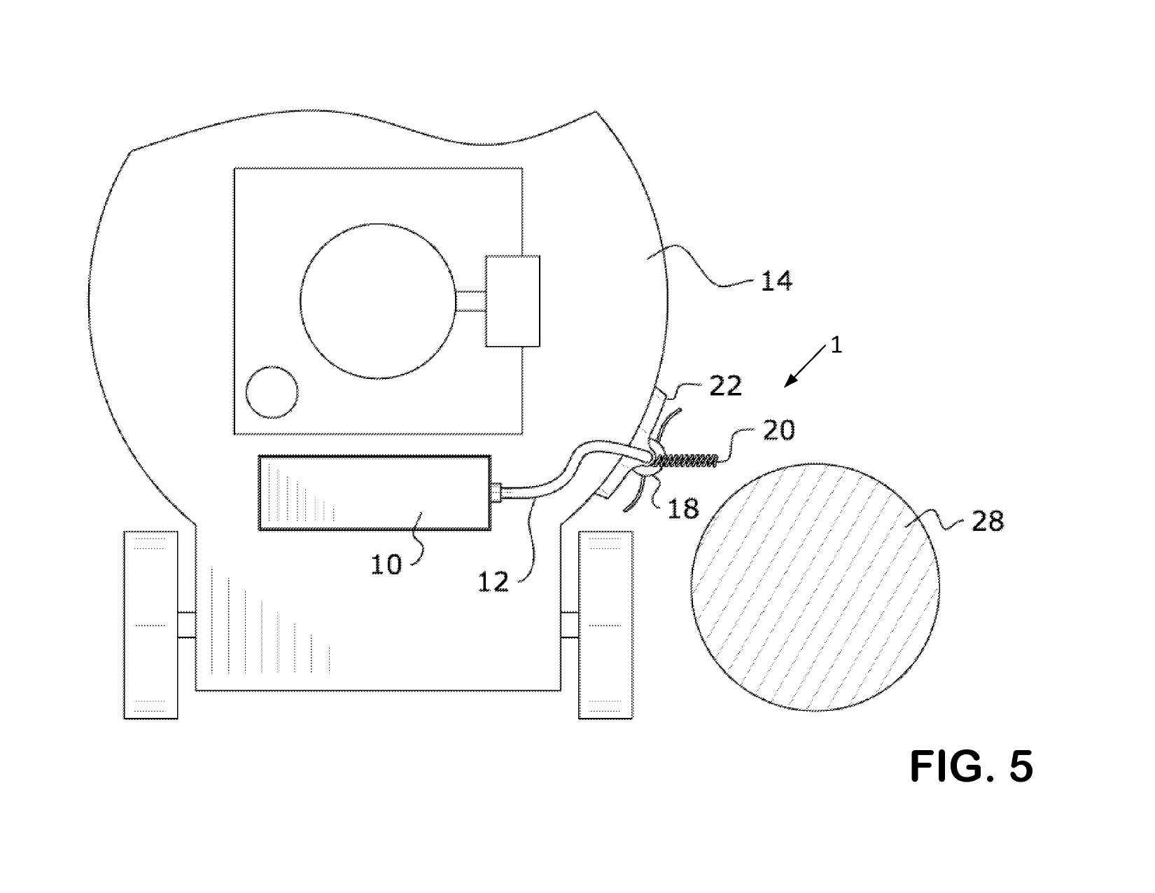

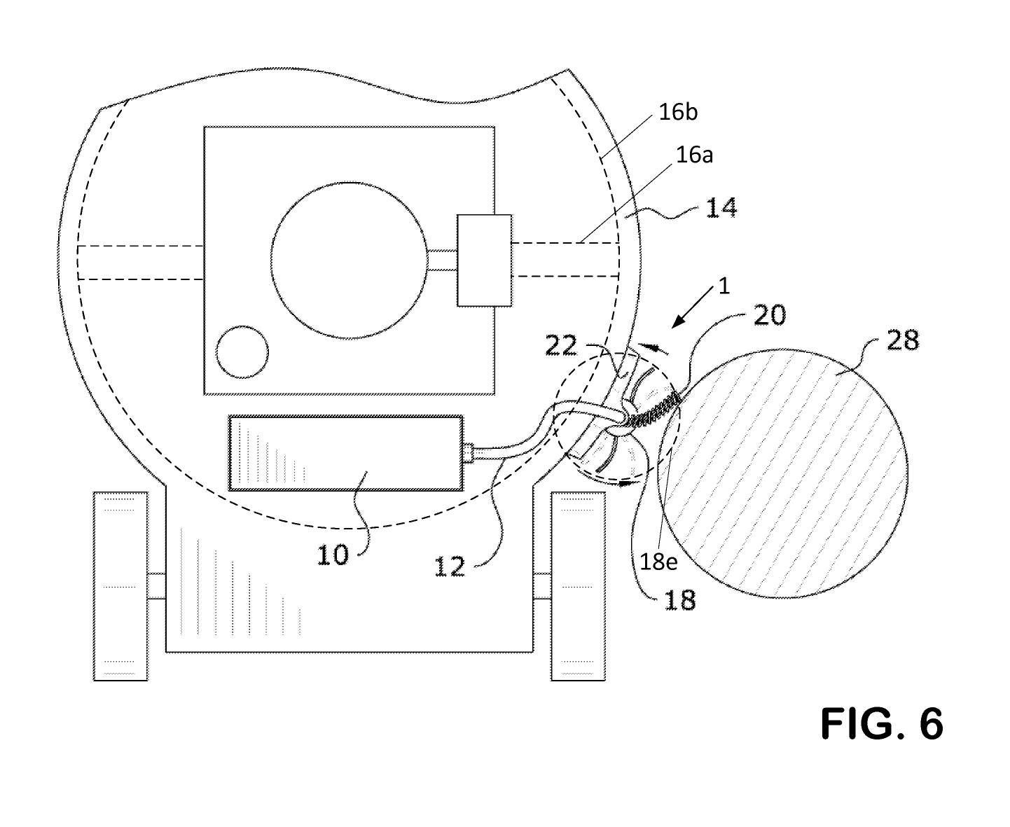

The operation of automatic switch with respect to an object 28 is most easily seen at FIGS. 5 and 6. As shown, automatic switch 20 includes a helical spring that, when sufficiently bent (see FIG. 6), closes the contacts of an electric circuit including the battery 10a and the electrical motor 10b. As shown, when not bent, the automatic switch 20 extends in a direction that is generally perpendicular to an axis of rotation of the trimming head 18a.

As stated previously, a drive shaft 12 may be provided to transmit rotational power from the power source 10 to the trimming head 18a of the trimming head assembly 18. In one embodiment, the drive shaft 12 includes an outer protective casing 12a and an internal shaft portion 12b (see FIG. 11) that is rotatable within the casing wherein both the shaft and casing are flexible. In one embodiment, the flexible shaft portion 12b is a steel cable. As shown, the shaft portion 12b of the drive shaft 12 is mechanically coupled to the trimming head 18a and the outer casing is secured to or within the fixed rod 18c. In one embodiment, the fixed rod 18c and the outer protective casing 12a are the same component while in others a connection point within the bracket 22 is provided. It is noted that in some applications, for example where the location between the power source 10 and the trimming head assembly is predetermined or fixed, that drive shaft 12 may be rigid instead of flexible.

The trimming device 1 further includes a mounting bracket assembly 22. Mounting bracket assembly 22 is for magnetically securing the trimming head assembly 18 to a part of a lawnmower 16, for example to a lawnmower deck 14. As configured, the trimming head 18a is rotatably mounted to the flexible bracket 22 such that it is rotatable with respect to the mounting bracket assembly 22. In such an embodiment, the mounting bracket assembly 22 remains stationary with respect to the lawnmower 16 when the trimming head 18a is activated, as can be seen most easily at FIG. 6. As shown, the bracket 22 has a base part 22a, a magnetic part 22b, and a contact face 22c.

The contact face 22c is that portion of the bracket 22 which is configured to come into direct contact with the lawnmower surface to which the bracket is attached. As shown, the contact face 22c has a rectangular shape and is formed from a portion of the base part 22a and a portion of the magnetic part 22b. The base part 22a may be formed from a flexible material, such as a molded plastic. In one embodiment, the magnetic part 22b may be a rare earth magnet formed from rare earth elements and may be provided in flexible form in conjunction with a flexible base part 22a to allow the mounting bracket contact face 22c to flexibly conform to the contours of a mower deck 14. In one embodiment, the magnetic part 22b may include a plurality of spaced rigid magnets secured to a flexible base part 22a to allow the mounting bracket contact face 22c to flexibly conform to the contours of a mower deck 14. In one embodiment, the base part 22a is molded over the magnet part 22b. The flexibility of the bracket 22 is beneficial as the same trimming device 1 can be used to conform to the varying surfaces of a number of different types and styles of lawnmowers for maximum securement. As such, it is anticipated that magnetically attaching the weed line trimming device 1 will allow for easy installation and removal to different mowers.

It is also noted that the mounting bracket base part 22a is configured such that, when viewed from above, the trimming lines 18b extend beyond a plane 22d defined by the contact face 22c of the mounting bracket 22. This configuration allows for the trimming lines 18b to extend below the deck 14 of the lawnmower 16 when so attached. This configuration also allows for the rotational axis of the trimming head 18a to be parallel to and proximate to the plane 22d defined by the contact face 22c, which reduces the moment and normal forces exerted on the magnetized connection between the bracket 22 and the lawnmower deck 14. As such, a more secure connection results. In one embodiment, the rotational axis of the trimming head 18a is less than about 2 inches from the contact face plane 22d. Additionally, as the power source 10 is remote from the mounting bracket 22 in some embodiments, the mounting bracket 22 only needs to support the weight of the trimming head assembly 18, which also results in a more secure connection.

When the mounting bracket 22 is fastened to the side of the lawnmower deck, the weed line trimming device will be in a position horizontal to the ground and ready to trim weeds or grass. With reference to FIGS. 6 and 10, the mounting bracket(s) 22 may be mounted to a lawnmower deck 14 such that the cutting area 18e of the trimming device 1 extends beneath the deck 14 and overlaps with the cutting area 16b defined by the lawnmower cutting blade 16a. With reference to FIG. 10, which shows a pair of trimming devices 1, the mounting brackets 22 may be mounted to a lawnmower deck such that the cutting areas 18e either extends (lower device) or does not extend (upper device) past a vertical plane 14a defined by the knock-off portion or lateral side of the lawnmower deck 14. It is also noted that, trimming devices 1 could be mounted on each corner, for example four corners, of a lawnmower deck, if desired.

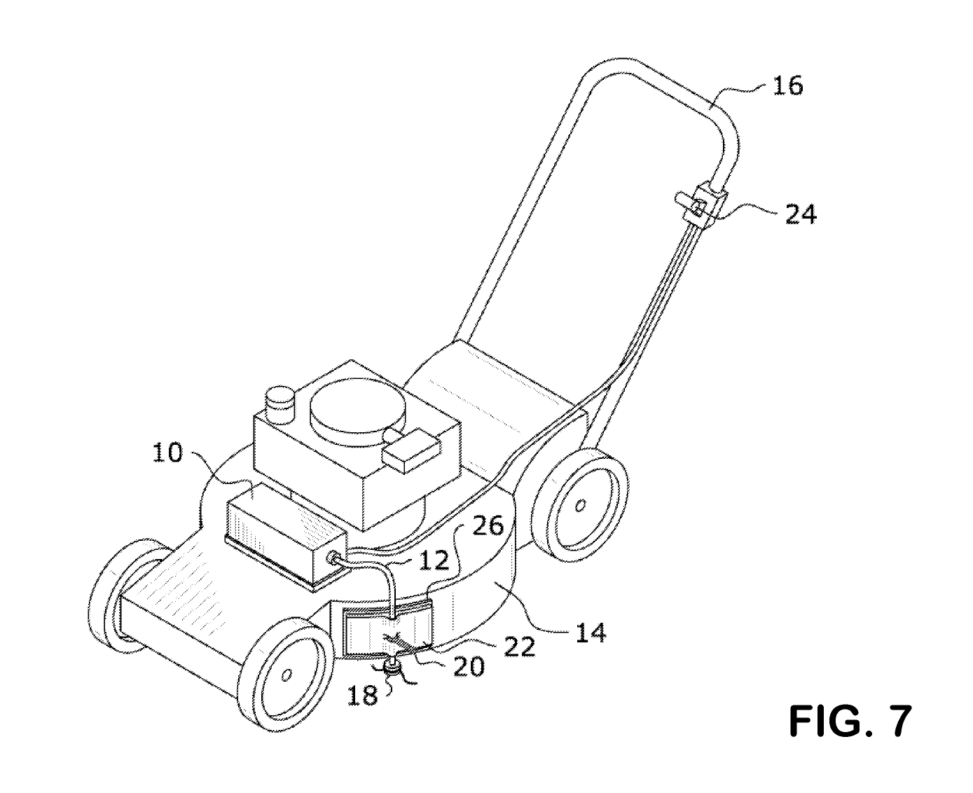

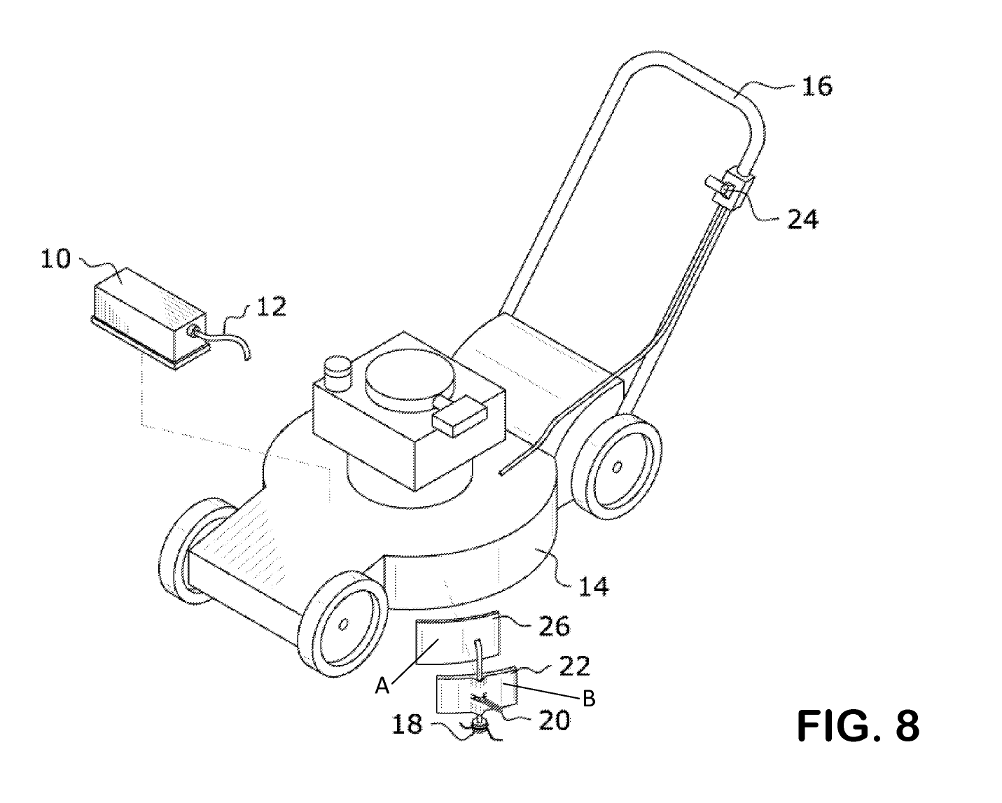

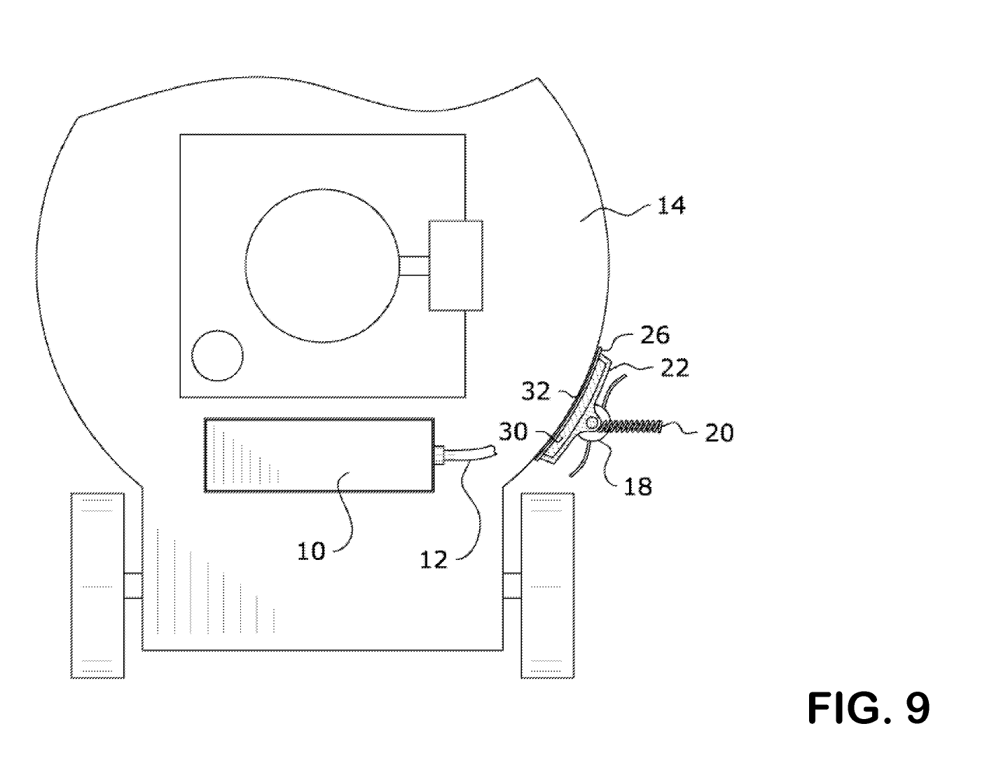

In applications where a lawnmower deck 14 is produced from a non-metallic material, such as plastic, and insert 26 may be used to allow mounting bracket 22 to be affixed to the lawnmower. Referring to FIGS. 7-9, insert 26 is shown as having an adhesive first side 26a and a metallic second side 26b, wherein the adhesive first side 26a is adhesively mounted to the curved side surface of the mowing deck 14 and the metallic second side 26b is configured to engage with the contact face 22c of the bracket 22. In one embodiment insert 26 is a metallic component to which an adhesive is applied to one side. As can be seen at FIGS. 7-9, the insert 26 has a generally rectangular shape similar to that of the contact face 22c and also has a surface area A that is greater than the surface area B of the contact face 22c of the bracket 22. However, it is noted that the insert 26 may be configured to have a surface area that is the same as or less than that of the contact face 22c. Furthermore, it is noted that insert 26 may be used with a metallic lawnmower deck 14, such as may be the case where the existing metallic lawnmower deck surface is insufficient (e.g. rusted, bent, etc.) for magnetized attachment.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A removable trimming device for a lawnmower comprising:
a) a trimming head assembly including a trimming head rotatably mounted to a flexible bracket having a magnetized face for removably mounting the trimming device head assembly to the lawnmower;
b) a flexible drive shaft having a first end and a second end, the first end being connected to the line trimming device head; and
c) an electrical power source including a mounting magnet and an electric motor connected to the second end of the flexible drive shaft, the electrical power source being configured to provide rotational energy to the line trimming device head through the flexible drive shaft, the mounting magnet being configured to removably mount the electrical power source to the lawnmower.

2. The removable trimming device of claim 1, further comprising a switch for activating the electrical power source.

3. The removable trimming device of claim 2, wherein the switch is mounted to the bracket of the trimming head assembly and extends in a direction that is generally perpendicular to an axis of rotation of the line trimming head.

4. The removable trimming device of claim 3, wherein the switch includes a flexible spring.

5. The removable trimming device of claim 1, wherein the bracket further comprises an insert having an adhesive first side and a metallic second side, wherein the adhesive first side is configured for adhesive attachment to the lawnmower and the metallic second side is configured for removable attachment to the magnetized face of the bracket.

6. The removable trimming device of claim 5, wherein a surface area of the insert is greater than a surface area of the magnetized face of the bracket.

7. The removable trimming device of claim 5, wherein the insert and the magnetized face of the bracket have a generally rectangular shape.

8. The removable trimming device of claim 1, wherein the line trimming device head includes at least one trimming line extending in a plane generally perpendicular to the bracket face.

9. The removable trimming device of claim 8, wherein the at least one trimming line extends under the bracket and beyond a plane defined by the face of the bracket when being rotated by the electrical power source.

10. The removable trimming device of claim 1, further comprising a guide disk mounted between the trimming device head and the mounting bracket.

11. The removable trimming device of claim 1, further comprising a second trimming head assembly including a second line trimming device head rotatably mounted to a second flexible bracket having a magnetized face for removably mounting the second trimming assembly to the lawnmower, the second trimming head assembly being connected to the power source by a second flexible drive shaft.

12. A mowing and removable trimming device combination comprising:
a) a lawnmower having a mowing deck, the mowing deck having a top surface and a curved side surface;
b) a trimming head assembly including a line trimming head rotatably mounted to a flexible bracket having a magnetized face, the magnetized face being removably mounted to the curved side surface of the lawnmower;
c) a flexible drive shaft having a first end and a second end, the first end being connected to the line trimming device head; and
d) an electrical power source including a mounting magnet and an electric motor connected to the second end of the flexible drive shaft, the electrical power source being configured to provide rotational energy to the line trimming device head through the flexible drive shaft, the electrical power source being removably mounted to the top surface of the mowing deck by the mounting magnet.

13. The mowing and removable trimming device combination of claim 12, further comprising a switch for activating the electrical power source.

14. The mowing and removable trimming device combination of claim 13, wherein the switch is mounted to the bracket of the trimming device head assembly and extends in a direction that is generally perpendicular to the curved side surface of the mowing deck.

15. The mowing and removable trimming device combination of claim 14, wherein the switch includes a flexible spring.

16. The mowing and removable trimming device combination of claim 12, wherein the bracket further comprises an insert having an adhesive first side and a metallic second side, wherein the adhesive first side is adhesively mounted to the curved side surface of the mowing deck and the metallic second side is removably attached to the magnetized face of the bracket.

17. The mowing and removable trimming device combination of claim 16, wherein a surface area of the insert is greater than a surface area of the magnetized face of the bracket.

18. The mowing and removable trimming device combination of claim 17, wherein the insert and the magnetized face of the bracket have a generally rectangular shape.

19. The mowing and removable trimming device combination of claim 12, wherein the line trimming device head includes at least one trimming line extending in a plane generally perpendicular to the bracket face.

20. The mowing and removable trimming device combination of claim 19, wherein the at least one trimming line extends under the bracket and beyond a plane defined by the face of the bracket when being rotated by the electrical power source.

21. The mowing and removable trimming device combination of claim 20, wherein the bracket is configured such that the at least one trimming line extends under the lawnmower deck when the line trimming device head is rotating, wherein the trimming device defines a cutting area that overlaps with a cutting are defined by a rotating blade of the lawnmower.

22. The mowing and removable trimming device combination of claim 11, further comprising a guide disk mounted between the trimming head and the mounting bracket.

23. The mowing and removable trimming device combination of claim 11, further comprising a second trimming head assembly including a second line trimming device head rotatably mounted to a second flexible bracket having a magnetized face for removably mounting the second trimming assembly to the lawnmower, the second trimming head assembly being connected to the power source by a second flexible drive shaft.

24. A removable trimming device for a lawnmower comprising:
a) a trimming head assembly including a trimming head rotatably mounted to a flexible bracket having a magnetized face for removably mounting the trimming device head assembly to the lawnmower, the trimming head including at least one trimming line defining a cutting area, the trimming head assembly including a guide disk disposed between the trimming head and the flexible bracket;
b) a flexible drive shaft having a first end and a second end, the first end being connected to the line trimming device head; and
c) an electrical power source including a mounting magnet and an electric motor connected to the second end of the flexible drive shaft, the electrical power source being configured to provide rotational energy to the line trimming device head through the flexible drive shaft, the mounting magnet being configured to removably mount the electrical power source to the lawnmower.

25. The removable trimming device of claim 24, wherein the rotational axis of the trimming head is less than 2 inches from the magnetized face of the flexible bracket.

26. The removable trimming device of claim 25, wherein the guide disk is from about 2 inches to about 3 inches in diameter.

27. The removable trimming device of claim 26, wherein the cutting area has a diameter greater than the diameter of the guide disk.

28. The removable trimming device of claim 27, wherein the cutting area has a diameter from about 3 inches to about 7 inches.

29. The removable trimming device of claim 24, wherein the guide disk is formed from a plastic material.
